(19) United States
(12) Patent Application Publication
(10) Pub. No.: US 2024/0234999 A1
(43) Pub. Date: Jul. 11, 2024

(54) DIAMOND WHISPERING-GALLERY MODE RESONATOR

(71) Applicant: RAYTHEON BBN TECHNOLOGIES CORP., Cambridge, MA (US)

(72) Inventors: Moe D. SOLTANI, Belmont, MA (US); Gerhard SOLLNER, Lincoln, MA (US); Matthew A. MORTON, Lynnfield, MA (US); James A. DERVAY, Hudson, MA (US); Leonardo Matteo RANZANI, Acton, MA (US); Kenneth Michael DINNDORF, Bedford, NH (US)

(21) Appl. No.: 18/408,159

(22) Filed: Jan. 9, 2024

Related U.S. Application Data
(60) Provisional application No. 63/438,220, filed on Jan. 10, 2023.

(51) Int. Cl. H01P 7/00; H01P 3/16

(52) U.S. Cl. CPC H01P 7/00; H01P 3/16

(57) ABSTRACT

A diamond whispering gallery mode resonator. In some embodiments, a system includes: a first whispering gallery mode resonator and a first waveguide. The first whispering gallery mode resonator may be composed of diamond. The first whispering gallery mode resonator may be coupled to the first waveguide, and the first whispering gallery mode resonator may be configured to support a first resonant mode having a frequency greater than 110 gigahertz.

### CROSS-REFERENCE TO RELATED APPLICATION(S)

The present application claims priority to and the benefit of U.S. Provisional Application No. 63/438,220, filed Jan. 10, 2023, entitled “Diamond Whispering Gallery Mode High Q Dielectric Resonators for G-Band”, the entire content of which is incorporated herein by reference.

### FIELD

One or more aspects of embodiments according to the present disclosure relate to millimeter wave (mm-wave) circuits, and more particularly to a diamond whispering-gallery mode resonator for mm-wave circuits.

### BACKGROUND

G band (110-300 GHZ) circuits have a wide range of military and commercial applications, including communications systems and radar systems. For electronic and communication systems in this frequency range, compact and low phase noise oscillators as well as filters are crucial elements to be included in such systems. For the realization of both oscillator and filter circuits, high Q resonators are important elements.

### SUMMARY

According to an embodiment of the present disclosure, there is provided a system, including: a first whispering gallery mode resonator; and a first waveguide, wherein: the first whispering gallery mode resonator is composed of diamond, the first whispering gallery mode resonator is coupled to the first waveguide, and the first whispering gallery mode resonator is configured to support a first resonant mode having a frequency greater than 110 gigahertz.

In some embodiments, the first waveguide is a dielectric waveguide.

In some embodiments, the system further includes a second waveguide, coupled to the first waveguide, the second waveguide being a metal waveguide.

In some embodiments, the first whispering gallery mode resonator overlaps the first waveguide in a plan view.

In some embodiments, the first waveguide is curved in a region of overlap.

In some embodiments: the first waveguide is on a substrate, and the first whispering gallery mode resonator is secured to the substrate by a post.

In some embodiments, the first whispering gallery mode resonator is a cylinder.

In some embodiments, the cylinder has a height between 0.2 millimeters and 2 millimeters and a diameter between 2 millimeters and 10 millimeters.

In some embodiments, the first whispering gallery mode resonator includes a portion of a cone.

In some embodiments: the portion of a cone is a truncated cone, and the truncated cone is secured to a substrate at the small end of the truncated cone.

In some embodiments, the system further includes a second whispering gallery mode resonator, coupled to the first whispering gallery mode resonator.

In some embodiments, the first whispering gallery mode resonator and the second whispering gallery mode resonator are configured to support a second resonant mode, the second resonant mode having an energy distribution with at least 30% of the energy in a gap between the first whispering gallery mode resonator and the second whispering gallery mode resonator.

In some embodiments, the system further includes an enclosure containing the first whispering gallery mode resonator and the second whispering gallery mode resonator.

In some embodiments, the enclosure is a conductive enclosure.

In some embodiments, the system includes a filter including the first whispering gallery mode resonator.

In some embodiments, the filter further includes a second whispering gallery mode resonator, coupled to the first whispering gallery mode resonator.

In some embodiments, the system further includes an oscillator including: the first whispering gallery mode resonator; and an amplifier coupled to the first waveguide.

In some embodiments, the volume of the oscillator is less than 20 cubic centimeters.

In some embodiments, the first whispering gallery mode resonator is a single crystal of diamond.

In some embodiments, the system further includes a second waveguide coupled to the first whispering gallery mode resonator.

### BRIEF DESCRIPTION OF THE DRAWINGS

Features, aspects, and embodiments are described in conjunction with the attached drawings, in which:

FIG. 1A is a perspective view of a portion of a system including a diamond whispering gallery mode resonator, according to an embodiment of the present disclosure;

FIG. 1B is an illustration of an electric field pattern of a mode of a diamond whispering gallery mode resonator, according to an embodiment of the present disclosure;

FIG. 1C is an illustration of an electric field pattern of a mode of a diamond whispering gallery mode resonator, according to an embodiment of the present disclosure;

FIG. 1D is a schematic drawing of a coupling configuration, according to an embodiment of the present disclosure;

FIG. 1E is a schematic drawing of a coupling configuration, according to an embodiment of the present disclosure;

FIG. 1F is a schematic drawing of a coupling configuration, according to an embodiment of the present disclosure;

FIG. 1G is a schematic drawing of a coupling configuration, according to an embodiment of the present disclosure;

FIG. 1H is a schematic drawing of a coupling configuration, according to an embodiment of the present disclosure;

FIG. 1I is a schematic drawing of a coupling configuration, according to an embodiment of the present disclosure;

FIG. 2A is a perspective view of a portion of a system including a diamond whispering gallery mode resonator, according to an embodiment of the present disclosure;

FIG. 2B is a perspective view of a portion of a system including a diamond whispering gallery mode resonator, according to an embodiment of the present disclosure;

FIG. 2C is a cross-sectional view of a portion of a system including a diamond whispering gallery mode resonator, according to an embodiment of the present disclosure;

FIG. 2D is a perspective view of a portion of a system including a diamond whispering gallery mode resonator, according to an embodiment of the present disclosure;

FIG. 2E is a cross-sectional view of a portion of a system including a diamond whispering gallery mode resonator, according to an embodiment of the present disclosure;

FIG. 3 is a perspective view of a portion of a system including a diamond whispering gallery mode resonator, according to an embodiment of the present disclosure;

FIG. 4 is a cross sectional view of a diamond whispering gallery mode resonator in the shape of a truncated cone, and the shape of a whispering gallery mode it may support, according to an embodiment of the present disclosure;

FIG. 5A is a schematic perspective view of an oscillator including a diamond whispering gallery mode resonator, according to an embodiment of the present disclosure;

FIG. 5B is a cross-sectional view of a portion of an oscillator including a diamond whispering gallery mode resonator, according to an embodiment of the present disclosure;

FIG. 5C is a top view of an oscillator including a diamond whispering gallery mode resonator, according to an embodiment of the present disclosure;

FIG. 5D is a cutaway side view of an oscillator including a diamond whispering gallery mode resonator, according to an embodiment of the present disclosure;

FIG. 6A is a schematic perspective view of two coupled diamond whispering gallery mode resonators, according to an embodiment of the present disclosure;

FIG. 6B is an illustration of a mode supported by two coupled diamond whispering gallery mode resonators, according to an embodiment of the present disclosure; and

FIG. 6C is a schematic perspective view of two coupled diamond whispering gallery mode resonators in an enclosure, according to an embodiment of the present disclosure.

### DETAILED DESCRIPTION

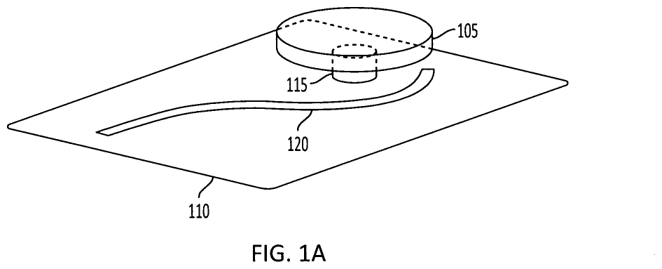

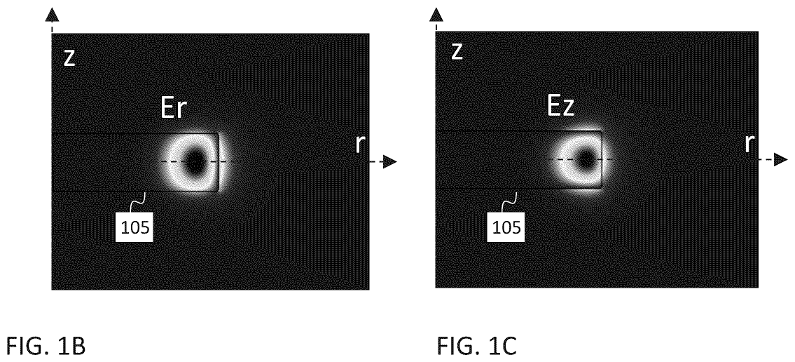

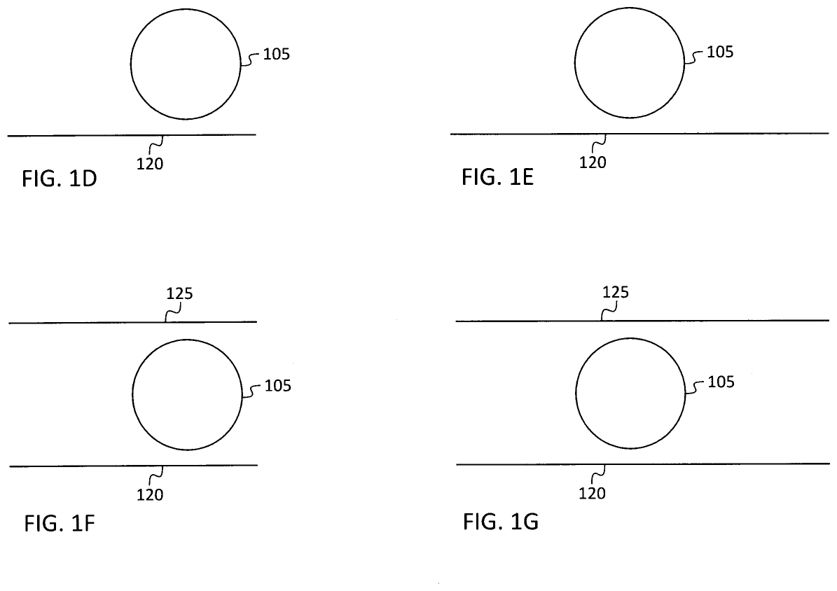

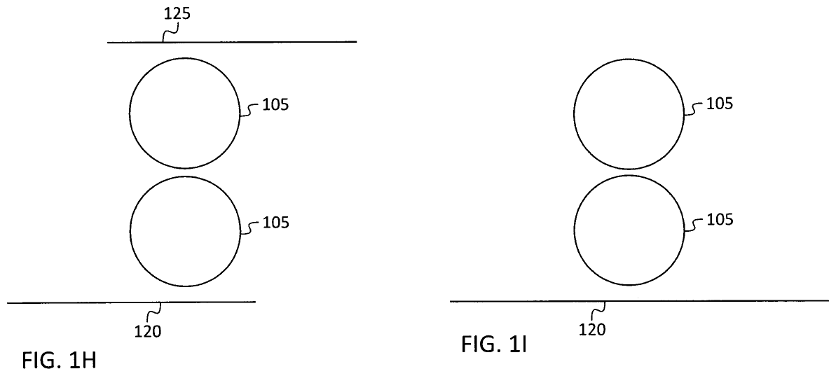

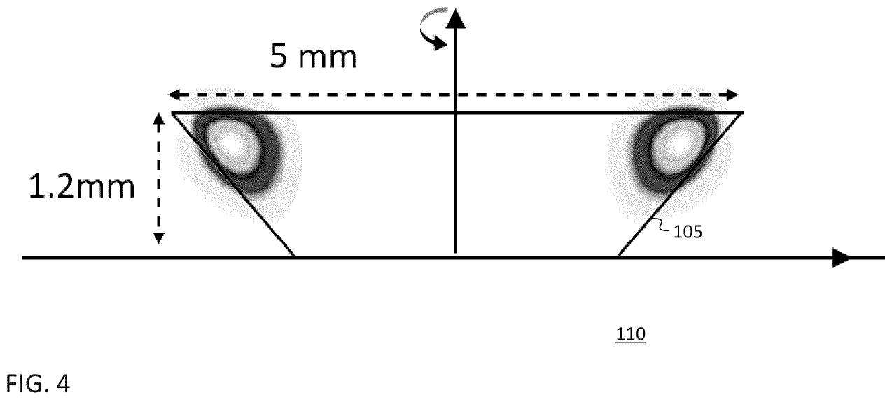

The detailed description set forth below in connection with the appended drawings is intended as a description of exemplary embodiments of a diamond whispering-gallery mode resonator for mm-wave circuits provided in accordance with the present disclosure and is not intended to represent the only forms in which some embodiments may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features. Each of FIGS. 1A-1C and 2A-6C, is drawn to scale for a respective embodiment.

As mentioned above, G band (110 gigahertz (GHz)-300 GHz) circuits have a wide range of military and commercial applications, including communications systems and radar systems. Signals in this frequency range may be generated using, e.g., an X-band oscillator and a frequency multiplier, but the use of such an approach may result in a bulky system with high power consumption. Moreover, the phase noise of the X-band oscillator in such a system may be multiplied by the frequency multiplier, resulting in relatively poor phase noise performance at G band.

As such, in some embodiments, a G-band oscillator is constructed using a diamond whispering gallery mode resonator as the resonant element of the oscillator. High quality single-crystal diamond can have a loss tangent of less than 10×10⁻⁶ over the entire G band frequency range, and over a range of frequencies near 220 GHz as low as 2.5×10⁻⁶. This may make it possible to fabricate a diamond whispering gallery mode resonator with a Q of 200,000 at 150 GHz or with a Q of 400,000 at 220 GHz. A resonator with quality factor of 400,000 when used as part of an advance oscillator circuit architecture may result in (i) phase noise, in an oscillator using such a resonator, of less than 150 dB/Hz at an offset frequency of 10 KHz from the carrier, or (ii) root mean squared (RMS) phase noise of less than 0.5 degrees, e.g., less than 0.2 degrees. Referring to FIG. 1A, a diamond whispering gallery mode resonator 105 may have the shape of a cylinder (e.g., a disk), as shown. The thickness (or height) of the diamond whispering gallery mode resonator 105 may be between 0.5 mm and 2 mm (e.g., it may be within 20% of 1 mm) and the diameter of the diamond whispering gallery mode resonator 105 may be between 2 mm and 10 mm (e.g., it may be within 20% of 4 mm). These dimensions may vary with the frequency (e.g., they may scale approximately with the reciprocal of the frequency). As an example, at or near a frequency of 220 GHz, a diamond disk with a diameter between 3 mm and 6 mm and a thickness between 0.75 mm and 1.25 mm may be used as a high Q whispering gallery mode resonator.

A diamond whispering gallery mode resonator 105 may support multiple transverse electric (TE) azimuthal modes and transverse magnetic (TM) azimuthal modes, each with a respective azimuthal mode number and resonant frequency. For example, a diamond whispering gallery mode resonator 105 with a thickness of 1 mm and a diameter of 3 mm may have a TE mode with a resonant frequency of 224.7 GHZ and with an azimuthal mode number of 11. A diamond whispering gallery mode resonator 105 with a thickness of 1 mm and a diameter of 6 mm may have (i) a TE mode with a resonant frequency of 168 GHz and with an azimuthal mode number of 19 and (ii) a TM mode with a resonant frequency of 165.6 GHz and with an azimuthal mode number of 19. The electric field patterns for these two modes are illustrated in FIGS. 1B and 1C, with the dark regions at the centers of the generally round mode patterns being regions of highest electric field.

The resonant frequencies, azimuthal mode numbers, and mode shapes may be calculated using an electromagnetic simulation tool such as COMSOL Multiphysics or High-Frequency Structure Simulator (HFSS). The diamond whispering gallery mode resonator 105 may be secured to, e.g., a substrate 110 by a post 115; the post may hold the diamond whispering gallery mode resonator 105 at a sufficient distance from the substrate 110 to prevent significant coupling between evanescent fields of the whispering gallery modes and the substrate 110 (coupling which, if present, could result in a reduction of the Q of the resonator 105).

Single crystal diamond wafers with a suitable thickness (e.g., 1 mm) are readily available from commercial manufacturers; they may be fabricated using a chemical vapor deposition (CVD) process. In one approach and using mechanical polishing the diamond may be polished into a disk shape with proper diameter to realize a whispering gallery mode resonator. Diamond has excellent thermal properties and low thermorefractive properties, causing a whispering gallery mode resonator 105 composed of diamond to have a stable resonant frequency and high radio frequency (RF) power handling capability. The diamond whispering gallery mode resonator 105 may be a single crystal of diamond, or it may be polycrystalline, e.g., composed of a plurality of crystals of diamond. In some embodiments a polycrystalline diamond whispering gallery mode resonator 105 may have a lower Q than a single crystal diamond whispering gallery mode resonator 105 of comparable dimensions.

A G-band signal may be coupled to the diamond whispering gallery mode resonator 105 from a waveguide 120 as shown in FIG. 1A. The waveguide may be a terminated waveguide, one end of which is connected to other circuit elements and the other end of which is terminated (as illustrated in FIG. 1A) with, e.g., a reflective or matched termination. FIG. 1D shows a schematic drawing of such a configuration, with a terminated waveguide 120 coupled to a diamond whispering gallery mode resonator 105. FIG. 1E is a schematic illustration of a through waveguide 120, that has two ends both of which may be connected other circuit elements, and that is coupled to the diamond whispering gallery mode resonator 105.

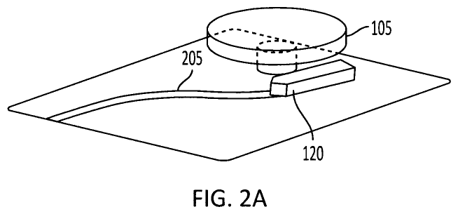

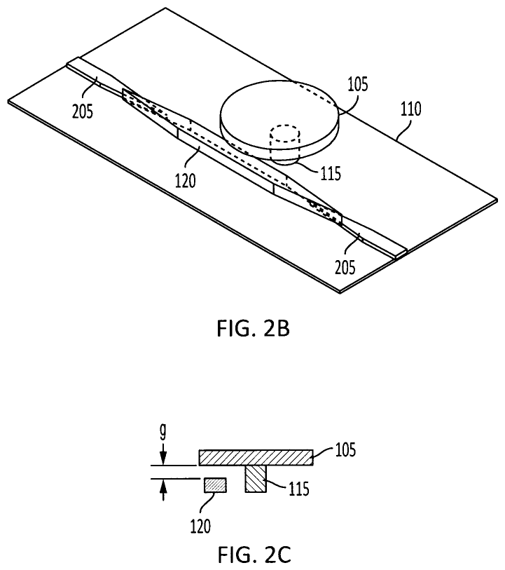

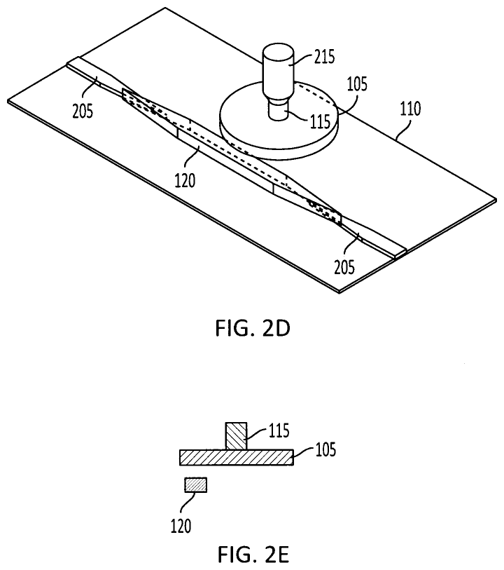

Each of FIGS. 1F and 1G is a schematic drawing of a coupling configuration including a first waveguide 120 and a second waveguide 125 each coupled to a diamond whispering gallery mode resonator 105. FIG. 1F shows a first terminated waveguide 120 and a second terminated waveguide 125 each coupled to a diamond whispering gallery mode resonator 105. The waveguides of FIG. 1F are coupled to whispering gallery modes with opposite directions of propagation; inbound waves in the first terminated waveguide 120 are coupled to a counterclockwise-propagating mode in the diamond whispering gallery mode resonator 105, and inbound waves in the second terminated waveguide 125 are coupled to a clockwise-propagating mode in the diamond whispering gallery mode resonator 105. FIG. 1G shows a first through waveguide 120 and a second through waveguide 125 each coupled to a diamond whispering gallery mode resonator 105. In some embodiments, two diamond whispering gallery mode resonators 105, 605 may be coupled to each other and to one or more waveguides, as illustrated in FIGS. 1H and 1I. FIGS. 1D to 1I are schematic drawings which are not to scale, and which are intended only to show various combinations of one or two waveguides (each of which may be a through waveguide or a terminated waveguide) and one or two diamond whispering gallery mode resonators. Each point at which a waveguide approaches a diamond whispering gallery mode resonator in these drawings is intended to represent proximity and electromagnetic coupling between the waveguide and the diamond whispering gallery mode resonator. Such coupling may be achieved by proximity between a surface of the waveguide and a surface of the diamond whispering gallery mode resonator, e.g., (i) proximity between a sidewall of a dielectric waveguide and the cylindrical wall of a diamond whispering gallery mode resonator, or (ii) (as illustrated in FIGS. 2B and 2C) proximity between the top surface of a dielectric waveguide and the bottom surface of a diamond whispering gallery mode resonator.

Other coupling configurations may be constructed. For example, a coupling configuration with a first terminated waveguide 120 and a second terminated waveguide 125 each coupled to a diamond whispering gallery mode resonator 105 may have the waveguides arranged to couple to whispering gallery modes with the same direction of propagation. As another example, some coupling configurations may have more than two waveguides. The embodiment of FIG. 1F or 1G may be used as a 1^{st} order band-pass filter, and the embodiment of FIG. 1D or 1E may be used as a 1^{st} order notch filter. The width and depth of the notch may be adjusted by adjusting the strength of the coupling between the waveguide 120 and the diamond whispering gallery mode resonator 105 (discussed in further detail below). A critically coupled resonator 105 may have the greatest extinction ratio (e.g., the greatest attenuation at the resonant frequency), whereas an under-coupled resonator may have the narrowest notch. For the design of higher order filters more resonators may be used and coupled to each other, as illustrated, for example, in FIGS. 1H and 1I. For example, for a 2^{nd} order filter, two coupled resonators may be used. In an application in which the resonator 105 is part of an oscillator, the best phase noise performance may be obtained for a resonator (e.g., an under-coupled resonator) with an extinction ratio of between 4 dB and 6 dB.

The waveguide 120 may be a metal waveguide (as illustrated in FIG. 1A, e.g., a transmission line such as a microstrip transmission line or a stripline transmission line) or a dielectric waveguide. FIG. 2A shows an embodiment in which the waveguide 120 is a dielectric waveguide. In such an embodiment, the inbound waves may be carried first by a metal waveguide 205 and then adiabatically coupled to the dielectric waveguide 120. FIG. 2B shows a similar configuration in which the waveguide 120 is a dielectric through waveguide, adiabatically coupled at each end to a respective metal transmission line 205. At each adiabatic transition between, e.g., a microstrip transmission line and a dielectric waveguide, the ends of both the microstrip transmission line and the dielectric waveguide may be tapered, as shown. The dielectric waveguide 120 may be composed of, for example, silicon (eps=11.7, α=3e-2), alumina ceramic (eps=9.3, α=3e-3), alumina crystal (eps=11.4, α=2e-4) or aluminum nitride ceramic (eps=8.85, α=1e-3). The substrate may be composed of, for example, quartz (eps=3.83, α=1e-3), high density polyethylene (HDPE) (eps=2.39, α=1e-3), polynorbornene (eps=2.36, α=6e-4), or polypropylene (eps=2.22, α=1e-3).

In the embodiment of FIG. 2B, the substrate 110 supports the post 115 and serves as the dielectric layer for the metal waveguide 205. FIG. 2C is a cross-sectional view of the embodiment of FIG. 2B, taken at a cutting plane passing through the center of the post 115 and through the point of closest approach between the waveguide 120 and the diamond whispering gallery mode resonator 105. The strength of the coupling between the waveguide 120 and the diamond whispering gallery mode resonator 105 may be adjusted by adjusting the dimension of the waveguide, or the size of the gap g (FIG. 2C) between the waveguide 120 and the diamond whispering gallery mode resonator 105, or by adjusting the curvature and the length of the curvature of the waveguide 120 (as discussed in further detail below).

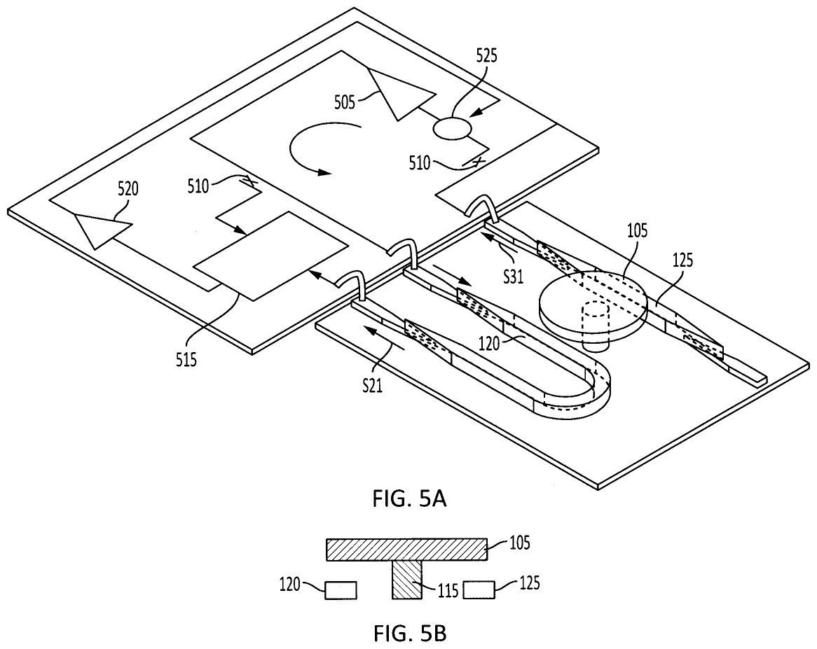

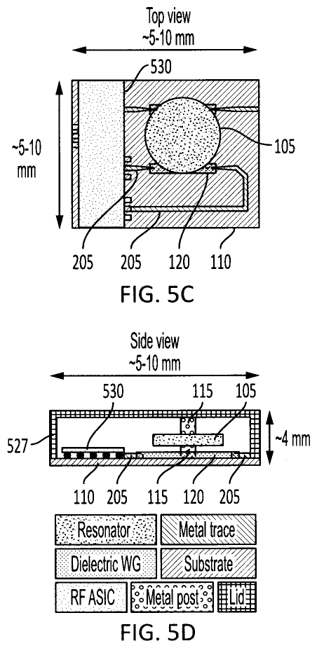

FIG. 2D shows an embodiment similar to the embodiment of FIG. 2B in which, instead of being supported by a post 115 secured to the substrate 110, the diamond whispering gallery mode resonator 105 is supported by a post 115 secured to the upper surface of the resonator 105, and to an inverted pedestal 215 which is secured to a support above the diamond whispering gallery mode resonator 105, e.g., an inner surface of an enclosure 527 containing the substrate 110 (FIG. 5C). FIG. 2E is a cross-sectional view of the embodiment of FIG. 2D, taken at a cutting plane passing through the center of the post and through the point of closest approach between the waveguide 120 and the diamond whispering gallery mode resonator 105.

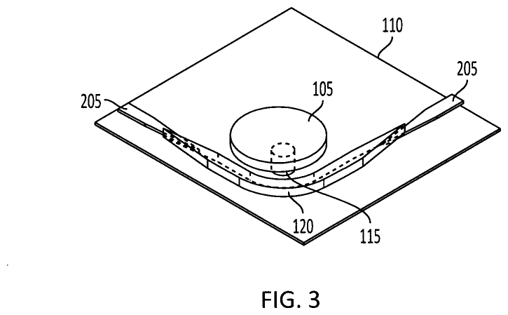

FIG. 3 is an illustration of an embodiment similar to those of FIGS. 2B and 2D; in the embodiment of FIG. 3, the waveguide is curved to follow the curvature of the diamond whispering gallery mode resonator 105, increasing the length of the section of the waveguide 120 from which evanescent fields may couple to the diamond whispering gallery mode resonator 105. As mentioned above, the strength of the coupling between the waveguide 120 and the diamond whispering gallery mode resonator 105 may be adjusted by adjusting the gap g (FIG. 2C) between the waveguide 120 and the diamond whispering gallery mode resonator 105, or by adjusting the curvature of the waveguide 120. For example, the strength of the coupling may be increased by decreasing the gap g or by using a waveguide that is curved, as, for example, in the embodiment of FIG. 3. The coupling strength may be calculated using an electromagnetic simulation tool such as COMSOL Multiphysics or High-Frequency Structure Simulator (HFSS). For example, COMSOL may be used to calculate the mode shape in the diamond whispering gallery mode resonator 105 and the mode shape in the waveguide 120, and numerical integration may be used to calculate the overlap and the coupling strength. Or alternatively, HFSS can be used to excite the mode of the waveguide and let it propagate to interact with the resonator, and through calculating the transmission between the resonator and the waveguide to find the coupling strength. In some embodiments, the size of the gap g is within 50% of 500 microns.

In some embodiments, the diamond whispering gallery mode resonator 105 includes a portion of a cone, e.g., the diamond whispering gallery mode resonator 105 is a truncated cone. The truncated cone may be secured to the substrate 110 at the small end of the truncated cone, as shown. FIG. 3 is a cross sectional view of a diamond whispering gallery mode resonator 105 in the shape of a truncated cone, and the shape of a whispering gallery modes it may support. The electric field pattern for this mode is illustrated with the dark regions at the centers of the generally round mode patterns being regions of highest electric field.

FIG. 5A shows a circuit of an oscillator including a diamond whispering gallery mode resonator 105, in some embodiments. The loop including a first amplifier 505 (which may be a gallium nitride amplifier) and the diamond whispering gallery mode resonator 105 has an open loop gain selected so that the closed-loop frequency response has a pair of poles in the right half plane at or near a resonant frequency of the diamond whispering gallery mode resonator 105. The drive signal from the first amplifier 505 is sampled by a directional coupler 510; this sampled signal is fed (along with the transmitted signal from the first waveguide 120, which is a through waveguide connected to the output of the first amplifier 505 and coupled to the diamond whispering gallery mode resonator 105) to a combining block 515 (which includes an interferometer and a mixer) to generate a phase error, which is amplified by a second amplifier 520 and fed to a phase modulator 525. The input of the first amplifier 505 is fed (through a directional coupler 510 and the phase modulator 525) by a signal from a second waveguide 125 which is also coupled to the diamond whispering gallery mode resonator 105. FIG. 5B is a cross-sectional view of the diamond whispering gallery mode resonator 105 and the two waveguides 120, 125.

FIG. 5C is a top view of an oscillator, in some embodiments. An active electronic circuit 530 is coupled to both ends of a through waveguide 120, which is coupled to a diamond whispering gallery mode resonator 105. The active electronic circuit 530 may include, for example, the components shown in FIG. 5A which is one representative oscillator circuit scheme, and, as such, may include an amplifier, a band pass filter, a power supply, a coupler, and a mixer. FIG. 5D is a side view of the oscillator. In the embodiment of FIGS. 5C and 5D, the diamond whispering gallery mode resonator 105 is supported by two posts, one of which is secured to the substrate 110 and one of which is secured to the top of the enclosure 527 (for ease of illustration, the posts are not shown in FIG. 5C). In some embodiments, the oscillator is constructed according to the circuit of FIG. 5A. An oscillator according to the embodiments of FIGS. 5C and 5D may have dimensions of approximately 8 mm×8 mm×4 mm, and, as such, it may be sufficiently compact to be used as the source of a local oscillator signal for a G-band phased array antenna without causing the dimensions of the antenna (including the oscillator) to be significantly greater than the array of radiators of the phased array antenna.

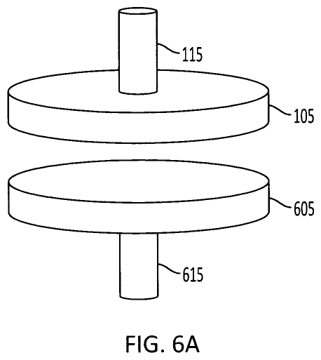

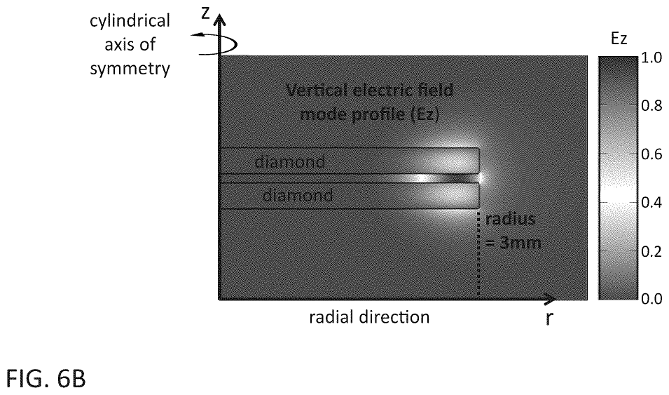

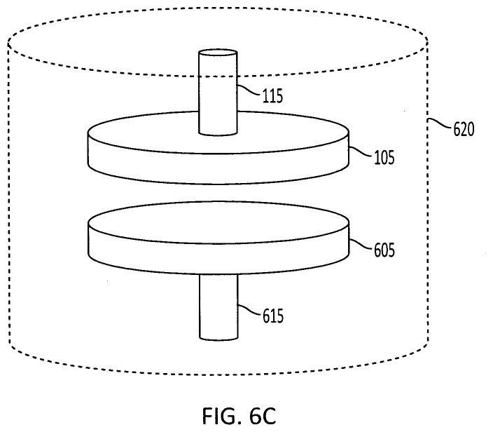

In some embodiments, two diamond whispering gallery mode resonators 105, 605 may be mounted near each other as illustrated in FIG. 6A. Such resonators may be coupled to each other and, if used as a filter (e.g., with a waveguide 120 coupled to one or each of the resonators 105, 605), the presence of two resonators may make it possible to achieve a higher-order filter frequency response (e.g., a frequency response having four poles at a resonant frequency or the resonators 105, 605). In some embodiments, the separation between the resonators 105, 605 and the dimensions of the resonators 105, 605 may be selected such that the pair of resonators 105, 605 supports a mode in which most of the energy is in the gap between the resonators 105, 605. Such a mode (illustrated in FIG. 6B, with the dark region at the center of the generally elliptical mode pattern near the edge of the gap being the region of highest electric field) may have a higher Q (because of the relatively low loss of the air in the gap (or of the vacuum in the gap, if the structure is in vacuum)). The configuration of FIG. 6B includes double diamond disks each with a radius of 3 mm, and a thickness of 0.3 mm, separated by a gap of 0.1 mm. The azimuthal mode number is m=21, and the frequency is approximately 225 GHz. In the mode illustrated in FIG. 6B, approximately 305 of the energy of the resonant mode is in the gap (e.g., in air, if the gap contains air). In some embodiments, such a mode may be used to characterize or enhance the electromagnetic interaction with molecules or vapor atoms that are present in the gap. In some embodiments, such a mode is supported for a relatively small gap. In other embodiments, for a larger gap, for which the coupling between the diamond whispering gallery mode resonators is smaller, such a mode is not supported; however a higher-order bandpass (or band stop) filter may be realized.

In some embodiments, the pair of resonators 105, 605 is in an enclosure 620, as illustrated in FIG. 6C. Such an enclosure 620 may be conductive and provide electromagnetic shielding, or it may be hermetically sealed and evacuated, or it may be fitted with a heater and temperature sensor and configured to provide a temperature-controlled environment. One or more waveguide ports (not shown) may be present, allowing waveguides (not shown) from the exterior of the enclosure 620 to be coupled to one or both of the resonators 105, 605. Such ports may be simply holes in the enclosure if the enclosure 620 is not hermetic. If the enclosure 620 is hermetic, then at each such hole the waveguide may be sealed to the wall of the enclosure 620 to preserve its hermeticity. For example, a dielectric waveguide may be sealed to the perimeter of the hole by a cladding layer having a lower dielectric constant than that of the waveguide. A metal waveguide (e.g., a coaxial transmission line) which has an outer ground conductor may preserve the hermeticity of the enclosure 620 by having its outer conductor sealed (e.g., soldered or welded) to the wall of the enclosure 620.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y%” of a first number, it means that the second number is at least (1-Y/100) times the first number and the second number is at most (1+Y/100) times the first number. As used herein, the word “or” is inclusive, so that, for example, “A or B” means any one of (i) A, (ii) B, and (iii) A and B.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

As used herein, the term “major component” refers to a component that is present in a composition, polymer, or product in an amount greater than an amount of any other single component in the composition or product. In contrast, the term “primary component” refers to a component that makes up at least 50% by weight or more of the composition, polymer, or product. As used herein, the term “major portion”, when applied to a plurality of items, means at least half of the items. As used herein, any structure or layer that is described as being “made of” or “composed of” a substance should be understood (i) in some embodiments, to contain that substance as the primary component or (ii) in some embodiments, to contain that substance as the major component.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Although limited embodiments of a diamond whispering-gallery mode resonator for mm-wave circuits have been specifically described and illustrated herein, many modifications and variations will be apparent to those skilled in the art. Accordingly, it is to be understood that a diamond whispering-gallery mode resonator for mm-wave circuits employed according to principles of this disclosure may be embodied other than as specifically described herein. Features of some embodiments are also defined in the following claims, and equivalents thereof.

What is claimed is:

1. A system, comprising:
a first whispering gallery mode resonator; and
a first waveguide,
wherein:
the first whispering gallery mode resonator is composed of diamond,
the first whispering gallery mode resonator is coupled to the first waveguide, and
the first whispering gallery mode resonator is configured to support a first resonant mode having a frequency greater than 110 gigahertz.

2. The system of claim 1, wherein the first waveguide is a dielectric waveguide.

3. The system of claim 1, further comprising a second waveguide, coupled to the first waveguide, the second waveguide being a metal waveguide.

4. The system of claim 1, wherein the first whispering gallery mode resonator overlaps the first waveguide in a plan view.

5. The system of claim 3, wherein the first waveguide is curved in a region of overlap.

6. The system of claim 1, wherein:
the first waveguide is on a substrate, and
the first whispering gallery mode resonator is secured to the substrate by a post.

7. The system of claim 1, wherein the first whispering gallery mode resonator is a cylinder.

8. The system of claim 7, wherein the cylinder has a height between 0.2 millimeters and 2 millimeters and a diameter between 2 millimeters and 10 millimeters.

9. The system of claim 1, wherein the first whispering gallery mode resonator comprises a portion of a cone.

10. The system of claim 9, wherein:
the portion of a cone is a truncated cone, and
the truncated cone is secured to a substrate at the small end of the truncated cone.

11. The system of claim 1, further comprising a second whispering gallery mode resonator, coupled to the first whispering gallery mode resonator.

12. The system of claim 11, wherein the first whispering gallery mode resonator and the second whispering gallery mode resonator are configured to support a second resonant mode, the second resonant mode having an energy distribution with at least 30% of the energy in a gap between the first whispering gallery mode resonator and the second whispering gallery mode resonator.

13. The system of claim 12, further comprising an enclosure containing the first whispering gallery mode resonator and the second whispering gallery mode resonator.

14. The system of claim 13, wherein the enclosure is a conductive enclosure.

15. The system of claim 1, comprising a filter comprising the first whispering gallery mode resonator.

16. The system of claim 15, wherein the filter further comprises a second whispering gallery mode resonator, coupled to the first whispering gallery mode resonator.

17. The system of claim 1, comprising an oscillator comprising:
the first whispering gallery mode resonator; and
an amplifier coupled to the first waveguide.

18. The system of claim 17, wherein the volume of the oscillator is less than 20 cubic centimeters.

19. The system of claim 1, wherein the first whispering gallery mode resonator is a single crystal of diamond.

20. The system of claim 1, further comprising a second waveguide coupled to the first whispering gallery mode resonator.
